(19) United States
(12) Patent Application Publication
(10) Pub. No.: US 2016/0182314 A1
(43) Pub. Date: Jun. 23, 2016

(54) STREAMLINED PROVISIONING SYSTEM AND METHOD

(71) Applicant: NBCUniversal Media, LLC, New York, NY (US)

(72) Inventor: Jan-Christian Will, New York, NY (US)

(21) Appl. No.: 14/574,060

(22) Filed: Dec. 17, 2014

(51) Int. Cl. H04L 12/24; H04L 29/08

(52) U.S. Cl. CPC H04L 41/5054; H04L 67/16

(57) ABSTRACT

In one embodiment, a computer-implemented method may include creating one or more objects in response to a trigger event, converting the one or more objects to a provisioning message, and determining whether the provisioning message includes a request for an identity or an account using one or more rule calls. The computer-implemented method may also include, when the request is for the identity, determining a type of entity to provision and application accounts to provision for the entity using one or more rule calls, and when the request is for the account, determining which application accounts to provision for the entity using one or more rule calls. Further, computer-implemented method may include provisioning the application accounts for the entity as determined.

### BACKGROUND

The present disclosure relates generally to managing data and/or technology resources, and, more particularly, to streamlining the provisioning and de-provisioning of data and/or technology resources to entities using a common enrichment process.

As used herein, provisioning refers to providing entities (e.g., users, clients, and/or customers) with access to data and/or technology resources and de-provisioning refers to removing and/or disabling entity (e.g., user, client and/or customer) access to data and/or technology resources. Also, the term “technology resources” may refer to technology related systems, such as: software applications, databases, networks, file directories, data feeds, and so forth.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Organizations typically use a diverse set of technology resources (e.g., information-technology (IT) systems, software applications, networks, and/or databases) to run their businesses, manage employees, contractors, customers, etc., communicate with third-parties, and so forth. Oftentimes, it is a cumbersome task to manage account, group, and identity objects across the diverse set of technology resources. Rules may be used that provide entities, such as employees or contractors, with different accounts and/or access rights to different technology resources. For example, an employee may be provisioned read and write access rights to an internal file share system, whereas a contractor may only be provisioned access rights to read from the internal file share system. In some instances, an entity that already exists in a system may be provisioned additional technology resources, such as an account to a software application, or the like. In another slightly more complicated example, an employee may be converted to a contractor, thereby necessitating de-provisioning certain technology resources and/or provisioning different technology resources. As may be appreciated, as more technology resources and/or entities are added and/or removed from the organizations, the rules that govern the provisioning and de-provisioning of technology resources to the entities may be duplicated and become unmanageable.

### BRIEF DESCRIPTION

Certain embodiments commensurate in scope with the originally claimed subject matter are summarized below. These embodiments are not intended to limit the scope of the claimed subject matter, but rather these embodiments are intended only to provide a brief summary of possible forms of the subject matter. Indeed, the subject matter may encompass a variety of forms that may be similar to or different from the embodiments set forth below.

In one embodiment, a computer-implemented method may include creating one or more objects in response to a trigger event, converting the one or more objects to a provisioning message, and determining whether the provisioning message includes a request for an identity or an account using one or more rule calls. The computer-implemented method may also include, when the request is for the identity, determining a type of entity to provision and application accounts to provision for the entity using one or more rule calls, and when the request is for the account, determining which application accounts to provision for the entity using one or more rule calls. Further, computer-implemented method may include provisioning the application accounts for the entity as determined.

In one embodiment, a system may include a processor-based workstation, a processor-based provisioning system, and one or more data sources, technology resources, or both. The processor-based provisioning system may be configured to create one or more objects in response to a trigger event activated by the processor-based workstation, convert the one or more objects to a provisioning message, determine whether the provisioning message includes a request for an identity or an account for the one or more data sources, technology resources, or both using one or more rule calls. When the request is for the identity, the processor-based provisioning system may be configured to determine a type of entity to provision and accounts, access rights, or both for the one or more data sources, technology resources, or both to provision for the entity using one or more rule calls. When the request is for the account for the one or more data sources, technology resources, or both, the processor-based provisioning system may be configured to determine which of the one or more data sources, technology resources, or both accounts, access rights, or both to provision for the entity using one or more rule calls. Further, the processor-based provisioning system may be configured to provision the one or more data sources, technology resources, or both accounts, access rights, or both for the entity as determined.

In one embodiment, a processor-based device may be configured to create one or more objects in response to a trigger event, convert the one or more objects to a provisioning message, and determine whether the provisioning message includes a request for an identity or an account using one or more rule calls. When the request is for the identity, the processor-based device may be configured to determine a type of entity to provision and accounts to provision for the entity using one or more rule calls. When the request is for the account, the processor-based device may be configured to determine which of the accounts to provision for the entity using one or more rule calls. Further, the processor-based device may be configured to provision the accounts for the entity as determined.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic view of a provisioning system, in accordance with an embodiment;

FIG. 2 is a flowchart illustrating a provisioning process using the system of FIG. 1, in accordance with an embodiment;

FIG. 3 is a schematic view illustrating a more detailed view of the provisioning system of FIG. 1, in accordance with an embodiment;

FIGS. 4A and 4B is a schematic view of a provisioning system that includes a rule based engine and a message enrichment process, in accordance with an embodiment; and

FIG. 5 is a flowchart illustrating a process for provisioning data and/or technology resources using the system of FIGS. 4A and 4B, in accordance with an embodiment.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. It should be noted that the term “entity” refers to a user of one or more technology resources, such as: an employee, customer, contractor, or partner, or a computer system, web service, or the like. In some scenarios, “entity” may refer to a group or subset of users of one or more technology resources. Also, the term “technology resources” refers to technology related systems (e.g., software applications, databases, networks, file directories, feeds, and so forth). Provisioning refers to providing entities (e.g., users, clients, and/or customers) with access to data and/or technology resources and de-provisioning refers to removing and/or disabling entity (e.g., user, client, and/or customer) access to data and/or technology resources.

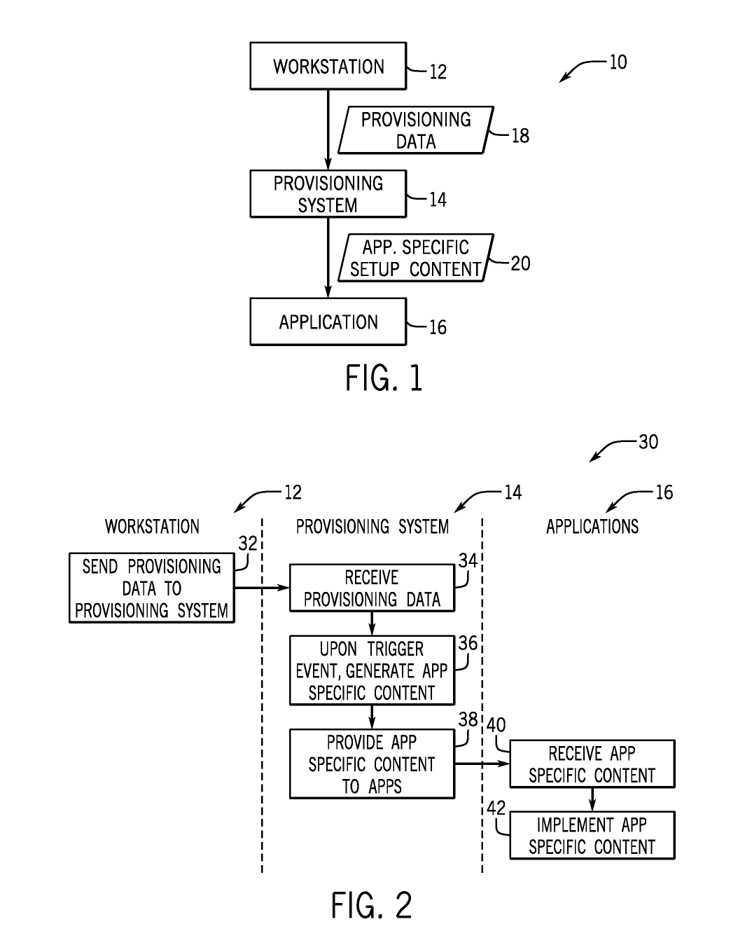

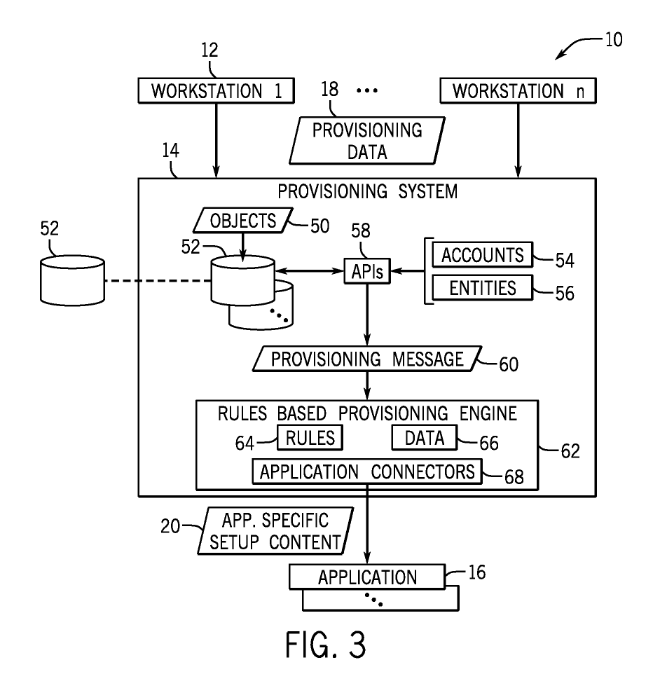

As previously mentioned, there exists an opportunity to more easily facilitate the provisioning and de-provisioning of data and/or technology resources associated with entities. For example, streamlining the process for creating and/or configuring software application accounts and access rights for new and existing employees, contractors, customers, and so forth, may be highly desirable. Accordingly, FIG. 1 is a schematic view of a system 10 for provisioning data, in accordance with an embodiment. The system 10 may streamline and simplify the provisioning and de-provisioning of data and/or technology resources associated with entities by enabling a standardized process to enrich initial provisioning data with various details (e.g., requester, owner, and object type) within the provisioning data prior to execution of function calls against the technology resources. FIG. 2 is a flowchart illustrating a provisioning process 30 using the system 10 of FIG. 1, in accordance with an embodiment. For clarity, FIGS. 1 and 2 will be discussed together.

The system 10 may include one or more workstations, a provisioning system 14, and one or more applications 16 or other technology resources. The workstations 12 may include an interactive console, such as a personal computer, laptop, terminal, and the like. The provisioning system 14 may be located on a server and may be accessed by the workstations 12 that serve as clients in a client-server architecture. The provisioning system 14 includes a non-transitory, machine-readable medium (e.g., flash storage, etc.) that may store machine-readable instructions to complete the process tasks described herein. In some embodiments, various aspects of the provisioning system 14 may be distributed among more than one server to enhance processing speed.

The workstations 12 may communicate with the provisioning system 14 via a wired (Ethernet) connection or wireless connection using any suitable wireless communication standard, such as Wi-Fi, ZigBee®, Bluetooth®, and so forth. In some embodiments, entities may be introduced, modified, and/or removed from the system 10. For example, a user in human resources (HR) may use the workstation 12 to add a new employee, modify accounts for technology resources for an existing employee, or delete the employee's information and accounts from an organization. During this process, entity details may be provided, modified, and/or deleted in the system 10. For example, when a user in HR is adding a new employee, the user may enter certain details of the employee, such as the employee's name, start date, type of employment (full-time employee, part-time employee), address, and the like. In some embodiments, the user may indicate a type of operation that is being requested, such as create, read, update, or delete. The information entered by the user may be encapsulated into provisioning data 18 and sent to the provisioning system 14 (block 32), where the provisioning data 18 is received by the provisioning system 14 (block 34).

Upon the occurrence of a trigger event, the provisioning system 14 may generate application specific content 20 (block 36). For example, in some embodiments, sending the provisioning data 18 to the provisioning system 14 may be considered a trigger event. Additional or alternative trigger events may include a specific date, such as a start date, hire date, etc., in the provisioning data 18, and when the specific date arrives, the provisioning system 14 may generate the application specific content 20. Also, the trigger event may include polling continuously for the receipt of the provisioning data 18, periodically checking for received provisioning data 18, and/or performing a batch operation to check for received provisioning data 18 and generate the application specific content 20 when the provisioning data 18 is found.

To generate the application specific content 20, the system 10 may enrich the provisioning data 18 by retrieving information already stored in the provisioning system 14 and/or retrieving the information from an external source. The provisioning system 14 may also convert the provisioning data 18 into the application specific content 20 in a common data format (e.g., extensible markup language (XML)), understandable by one or more of the applications 16. In some embodiments, the application specific content 20 may include substantial details related to the applications, the entity, and/or the account to provision or de-provision.

Once the application specific content 20 is generated, the provisioning system 14 may provide the application specific content 20 to the applications 16 (block 38), such that the applications 16 may receive the application specific content 20 (block 40). For example, one or more connectors may be provided between the provisioning system 14 and the application 16. The connectors may provide a data pathway enabling data communication between provisioning system 14 and the applications 16. Thus, the application specific content 20 may be received by the application 16 via these connectors.

Upon receipt of the application specific content 20, the applications 16 may implement the application specific content 20 (block 42). Implementing the application specific content 20 may include processing the application specific content 20 and performing the operations requested/defined in the application specific content 20, such as creating, updating, or deleting an account using the entity's information (e.g., ID, name, etc.) and account information (e.g., SSO number, etc.), and/or creating, updating, or deleting access rights using the user's information (e.g., ID, name, etc.) and account information (e.g., SSO number, etc.).

By using the process 30, the system 10 may enable streamlining and simplifying the provisioning and de-provisioning of entities, application accounts, and access rights for the entities. For example, using a common provisioning/de-provisioning process 30 may enhance the efficiency, scalability, and maintainability of the system 10 by allowing a multitude of diverse feeds and/or applications 16 to be provisioned and de-provisioned, without reliance on customized procedures for each data source and/or technology resource.

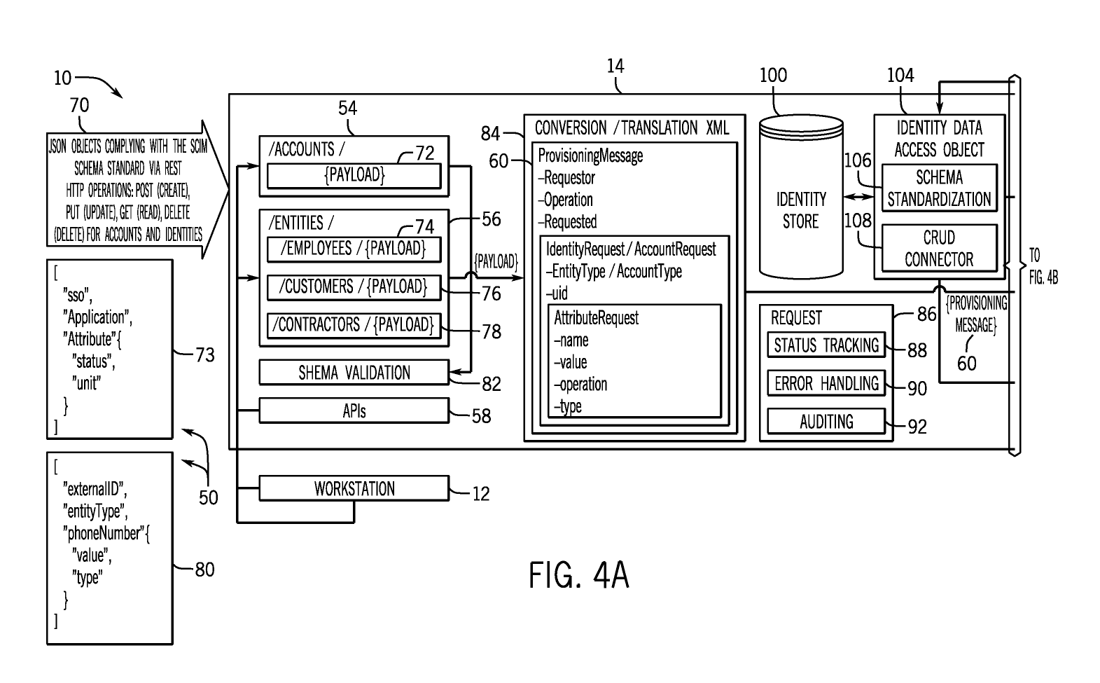

Turning now to a more detailed discussion of the provisioning system 14, FIG. 3 is a schematic view of provisioning components of the provisioning system 14, in accordance with an embodiment. As shown in the depicted embodiment, there may be any suitable number of workstations 12 communicably coupled to the provisioning system 14. In some embodiments, the workstations 12 may provide the provisioning data 18 to the provisioning system 14. For example, a workstation 12 user may input information (e.g., HR records, etc.) into an application of the workstation 12, which may be provided to the provisioning system 14.

In some embodiments, the provisioning data 18 may be sent in a lightweight data-interchange format, such as JavaScript object notation (JSON). The data-interchange format may include data in a collection of name/value pairs that make up an object 50. In some embodiments, the object 50 may be created upon the occurrence of a trigger event. The object 50 may be stored in one or more data repositories 52 accessible by the provisioning system 14. As illustrated, the data repositories 52 may be located locally (e.g., on the same server) to the provisioning system 14 and/or remotely (e.g., on a different server, such as on a cloud environment) to the provisioning system 14.

The objects 50 may comply with a schema specification that defines the particular data-interchange format. For example, the JSON object 50 may comply with the system for cross-domain identity management (SCIM) standard. The schema may be platform neutral and enable representing entities and groups of entities in JSON and XML formats. Thus, due to the schema's platform neutrality, the schema may enable efficiently managing entity identity and accounts in a provisioning system 14 that interfaces with numerous applications across different domains.

Depending on the type of request entered by the user or other system, creating the object 50 may correspond to creating a new account and/or entity, such as an employee, customer, contractor, system, or the like. The object 50 may be populated with information including account data 56 and/or entity data 58. The account data 56 may relate to information about the application account (e.g., application account number, application name, attributes of the application account) for which provisioning and/or de-provisioning is being requested. The entity data 58 may relate to information about the entity (e.g., entity ID number, entity type, address information, name, technology resource information (name, ID) when provisioning and/or de-provisioning a service account) for which provisioning and/or de-provisioning of data and/or technology resources is being requested.

In some embodiments, the account data 56 and/or entity data 58 may be provided by the user in the provisioning data 18. Further, this data may be retrieved via one or more application programming interfaces (APIs) 58 upon creation of the object 50.

The account data 54 returned from the APIs 58 may be encapsulated in a payload (body information of the object 50). The account data 54 may include a single sign on (SSO) number for the application for which the provisioned account is being requested, an application name for which the provisioned account is being requested, and/or one or more attributes of the account, such as a status, a unit, and the like.

In some embodiments, the entity data 56 returned from the APIs 58 may be encapsulated in a payload. The entity data 56 may include an identity (ID) number of the entity, a type of entity, such as employee, contractor, customer, another computer system, or the like. Also, the entity data 56 may include a phone number, address, and so forth, for the entity that accounts and/or access rights to applications are being provisioned or de-provisioned.

The APIs 58 may include hypertext transfer protocol (HTTP) web services that adhere to representational state transfer (REST) architecture constraints. The REST constraints may include using a base universal resource indicator (URI), an Internet media type for data, standard HTTP methods, hypertext links to reference a state, hypertext links to reference related technology resources, and the like. The HTTP methods used to implement the REST APIs 58 may include GET, PUT, POST, and DELETE methods, among others. For example, data may be fetched from the repositories 52 using the GET method, data may be replaced in the repositories 52 using the PUT method, new data may be created in the repositories 52 using the POST method, and data may be deleted from the repositories 52 using the DELETE method.

Once the data from the initial provisioning data 18 is populated in the object 50, the object 50 may be converted/translated into a provisioning message 60. The provisioning message 60 may be represented in a textual data format, such as the extensible markup language (XML). During the translation process, the provisioning message 60 may be enriched (e.g., supplemented) with additional details, such as an owner of the provisioned technology resources, and/or object type. Further, the generated provisioning message 60 may include markup of sections to be filled in by a rule based provisioning engine 62. For example, a provisioning plan markup section may be provided in the provisioning message 60 that includes requestor details to be filled in by the rule based provisioning engine 62. Enriching the provisioning message 60 prior to executing operations against target applications may enable more streamlined provisioning and de-provisioning of accounts for entities, by automatically gathering relevant provisioning information without requiring manual intervention of a user.

After conversion/translation is complete, the provisioning message 60 may be sent to the rule based engine 62 for further processing. The rule based engine 62 may receive the provisioning message 60 and make an initial determination as to whether the provisioning message 60 includes a request for an identity or for an account by calling one or more rules 64. Based on the type of request (identity or account), the rule calls indicate how and when (e.g., under what conditions) to provision or de-provision the accounts for the data and/or technology resources. In some embodiments, depending on the types of provisioning (e.g., to software, content, etc.) the rules 64 may implement conventional digital rights management (DRM) rules. In some embodiments, an example rule may indicate that if the request is for a new ID or an existing ID, then the rule based provisioning engine 62 takes different processing routes. Thus, provisioning and de-provisioning can be for new or existing entities. In either scenario, the rule based provisioning engine 62 may enrich the provisioning message 60 with additional data 66. For example, as previously discussed, the provisioning plan markup section in the provisioning message 60 may be populated with requestor details automatically by the rule based provisioning engine 62.

If the request in the provisioning message 60 is for an identity, then the rule based engine 62 may determine the type of entity (contractor, employee, customer, etc.). The rule based engine 62 may perform a rule 64 call by passing the type of entity and type of request. For example, if the type of request is an identity request (e.g., a request to create a new identity in the system 10) and the type of entity is an employee in the provisioning message 60, then the rule may result in employee creation tasks (e.g., provisioning an email account, a VPN account, a particular software suite account, read and write access rights to the file share system, and so forth). As may be appreciated, the rule based engine 62 may access numerous application connectors 68 to deliver and set up the provisioned applications (such as applications on the employee's workstation). In some embodiments, the application connectors 68 may translate the provisioning message 68 into formats that may be understood by the respective applications 16 and execute the operation (create, update, delete) calls against the target applications 16 to provision or de-provision the accounts and/or access rights for the entity.

If the request in the provisioning message 60 is for new application accounts for an existing identity, then the rule based engine 62 may make rule 64 calls to determine what provisioning is allowed based on the identity of the entity and the request type (e.g., what software applications, access, or other provisions). For example, a contractor may be allowed to have accounts provisioned for a portion of the applications of a software application suite but not all of the applications. Depending on the rules, the appropriate application connectors 68 are accessed to deliver and set up the provisioned items (such as applications on the employee's workstation).

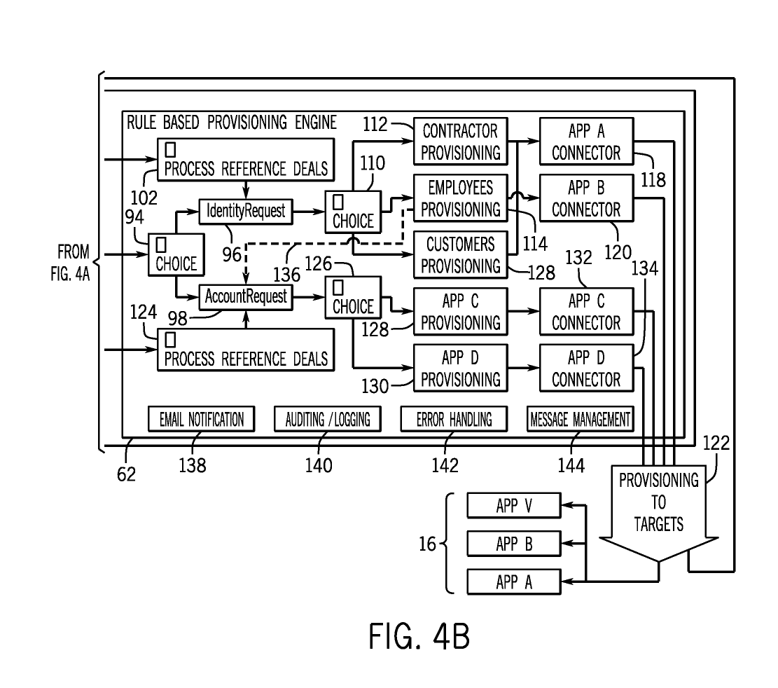

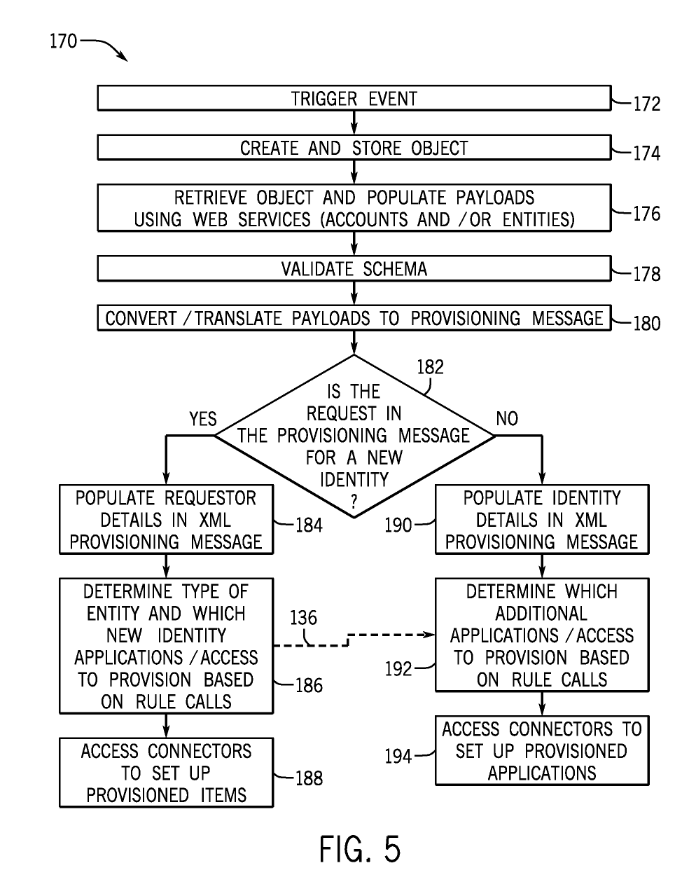

FIGS. 4A and 4B illustrate a detailed schematic view of a provisioning system 10 including the rule based engine 62 and a message enrichment process, in accordance with an embodiment. FIG. 5 is a flowchart illustrating a process 170 for provisioning data and/or technology resources using the system 10 of FIGS. 4A and 4B including the rule based engine 62 and the message enrichment process, in accordance with an embodiment. For clarity, FIGS. 4 and 5 will be discussed together.

The process 170 for provisioning data may begin with a trigger event 70 (block 172), upon which an object 50 is created and stored (block 174). As previously discussed, the trigger event 70 may include populating data using a workstation 12. For example, a user of an HR system, identity management system, or the like, may request provisioning or de-provisioning by entering information about accounts for a new entity or existing entity (polling for information) on a workstation 12, a specific date included with the entered information, such as a start date, a time interval that checks for received information by the provisioning system 14 (periodic basis), a batch process that finds entered information, and so forth.

Upon the trigger event 70, the object may be created, which may correspond, for example, to a new account/employee being created. As illustrated, the trigger event 70 may cause one or more JSON objects 50 to be created that include information about account data 54 for applications and/or entity data 56.

The JSON objects 50 may include header and payload (body) information. The provisioning system 14 may call APIs 58 to retrieve the objects 50 and to populate payload information for the objects 50 upon the trigger event 70 occurring (block 176). For example, the account data 54 may include a payload 72, which is illustrated in a JSON account object 73, that includes information about a single sign on (SSO) number for the application for which the provisioned account is being requested, an application name for which the provisioned account is being requested, and/or one or more attributes of the account, such as a status, a unit, and the like. The entity data 56 may include payloads for each entity, such as an employee payload 74, a customer payload 76, a contractor payload 78, and the like. The information in the entity payloads 74, 76, and 78 may include an identity (ID) number of the entity, a type of entity, such as employee, contractor, customer, another computer system, or the like, a phone number, an address, and so forth, as illustrated in the JSON entity object 80. As should be understood, the appropriate payload may be populated based on the type of entity for which the provisioning or de-provisioning request is being made.

After the payloads 72, 74, 76, and/or 78 are populated with available information, the process 170 may include validating the schema 82 of the objects 50 (block 178). This validation may include checking that the information provided is accurate, such as ID information, name, phone number, application, etc., and verifies the data formatting of the object 50 is correct.

After validation, the provisioning system 14 may use a conversion/translation service 84 to convert the payloads to a provisioning message 60 (block 180). The provisioning message 60 may be converted to a textual data-format such as XML. As illustrated, the provisioning message 60, in some embodiments, may include elements for a requestor, operation, and request ID. Further, the provisioning message 60 may include markup for an identity request/account request, which may be populated based on whether the request is for an identity or an account. This identity request/account request may further include elements for the entity type/account type and an ID. Embedded within the identity request/account request markup may be markup for an attribute request that includes elements for name, value, operation, and type. As previously discussed, the provisioning message 60 may also include a markup section for a provisioning plan where information about the requestor is provided later in the process 170. The conversion/translation service 84 may send the provisioning message 60 to the rule based provisioning engine 62.

In addition, a request service 85 may be running in the provisioning system 14 that may include functions for status tracking 88, error handling 90, and auditing 92. The status tracking 88 function may monitor the status of the provisioning system 14. For example, in some embodiments, the statuses may include “object created,” “conversion/translation to XML complete,” “conversion/translation to XML failed,” “provisioning message sent to rule based provisioning engine,” and so forth. The error handling function 90 may mitigate errors that occur in the provisioning system 14. For example, if the conversion/translation to XML fails, the error handling function 90 may attempt to resolve the issue or may catch any exceptions that are thrown by the provisioning system 14. The auditing 92 function may include auditing the type and number of accounts that have been provisioned to entities, the number of applications available to be provisioned, the number of entities in the provisioning system 14, and so forth.

Upon receipt of the provisioning message 60, the rule based provisioning engine 62 may make an initial determination 94 of whether the request in the provisioning message 60 is an identity request 96 or an account request 98 (decision block 182) in a first phase of decisions. This initial determination 94 may be thought of as an identity request 96 and account request 98 classification determination 86. The rule based engine 62 may make this determination 94 by processing the provisioning message 60 and making one or more rule calls. In some embodiments, the rule based provisioning engine 62 may make the rule calls using the entity ID and request type obtained from the provisioning message 60. If the entity ID does not exist in an identity store 100 and the request type is for a new identity, then the rule may indicate that the request is an identity request 96. If, on the other hand, the entity ID exists in the identity store 100 and the request type is for an additional application account, then the rule may indicate that the request is an account request 98. In some cases, when de-provisioning an entity is requested, the entity ID may exist in the identity store 100 but the request type may be to delete the identity, and the rule may indicate that the request is an identity request 96.

If the request is an identity request 96 to provision accounts for a new entity, the provisioning message 60 may be further enriched (e.g., populated/supplemented) with information related to the requestor (block 184) by making a “get requestor details” function call 102. As such, the “get requestor details” function call 102 may communicate with the identity store 100 via an identity data access object 104. The identity data access object 104 may include a component for a schema standardization 106 function and a create, read, update, and delete (CRUD) connector 108. The CRUD connector 108 may use its read function to obtain the requestor information from the identity store 100 and the schema standardization 106 function may normalize the data to be added to the XML provisioning message 60. Then, the identity data access object 104 may return the requestor information to the rule based provisioning engine 62 in response to the “get requestor details” function call 102. The rule based provisioning engine 62 may populate the provisioning plan markup section in the provisioning message 60 with the requestor details.

Then, the provisioning message 60 may pass through a second phase of decisions, where a rule call determination 110 is made by the rule based provisioning engine 62 to determine which type of entity and applications/access rights to provision to the entity (block 186). This rule call may indicate how to provision the entity's identity and which applications to provision to the entity based on the type of entity (contractor, employee, customer, etc.) and the request type in the provisioning message 60. It should be noted that at this point, the enriched XML provisioning message 60 contains all the information needed to make choices on how to provision the accounts for the different entities using the rules. As may be appreciated, the fully enriched XML provisioning message 60 may enable streamlining the provisioning or de-provisioning process by capturing all needed data prior to actually executing the provisioning or de-provisioning.

In some embodiments, there may be different rules used for provisioning different entity types, such as contractor provisioning 112, employee provisioning 114, customer provisioning 116, and so forth. Each type of provisioning 112, 114, and 116 may set up the identity of the entity in the identity store 100 using the CRUD connector 108 of the identity data access object 104. Further, each type of provisioning 112, 114, and 116 may be provisioned different accounts based on the rule for that particular entity type and request type. As a result, there may be application connectors (app A connector 118, app B connector 120) that are accessed if the rule indicates that the particular type of entity type provisioning should be provisioned that application account. For example, the rule for employee provisioning 114 may indicate that the employee should be provisioned an application account for email and virtual private network (VPN), which may correspond to the app A connector 118 and app B connector 120, respectively. On the other hand, the rule for contractor provisioning 114 may indicate that the contractor should be provisioned only an account for email and, thus, only access app A connector 118. It should be appreciated that the application connectors may correspond to any data source and/or technology resource (e.g., any software application, database, file share system, network, or the like). As previously discussed, the application connectors may be used to execute the provisioning to the target applications 16 (arrow 122) by delivering and setting up the provisioned applications 16 (such as applications on the employee's workstation). That is, the application connectors may perform create, update, or delete functions for accounts associated with the desired applications 16.

Returning to the initial determination 94 and focusing now on the account request 98 flow of events. In some embodiments, the rule based provisioning engine 62 may determine that the request in the provisioning message 60 is an account request 98 (decision block 182) in the first phase of decisions based on the rule call. The rule call may indicate that the request is an account request 98 when the entity ID exists in the identity store 100 and the request type is for an additional application to be provisioned to the entity.

Once determined to be an account request 98, the provisioning message 60 may be further enriched with information about the entity's identity (block 190). For example, the rule based provisioning engine 62 may make a “get identity details” function call 124. As such, the “get identity details” function call 124 may communicate with the identity store 100 via the identity data access object 104. The CRUD connector 108 may use its read function to obtain the identity information from the identity store 100 and the schema standardization 106 function may normalize the data to be added to the XML provisioning message 60. Then, the identity data access object 104 may return the identity information to the rule based provisioning engine 62 in response to the “get identity details” function call 124. The rule based provisioning engine 62 may populate the identity markup section in the provisioning message 60 with the identity details. The identity details may include the entity ID, the accounts provisioned to the identity, and so forth.

Then, the provisioning message 60 may pass through the second phase of decisions, where the rule based provisioning engine 62 may make a determination 126 of what additional application accounts and/or access rights to provision to the existing entity based on rule calls (block 192). The rule call may indicate the applications to provision based on the entity ID, entity type, request type, or some combination thereof. For example, a certain entity type, such as a contractor, may be provisioned a subset of a software application suite but not all of the software applications in the suite. Further, the request may be to provision an account that is prohibited for the entity's type and the rule call may indicate that the desired application account is not allowed for that entity type.

Based on the rule calls, the rule based provisioning engine 62 may modify the provisioning message 60 with the application account information to be provisioned (e.g., app C provisioning 128, app D provisioning 130). In some embodiments, accounts and/or access rights may be provisioned for: word processing software applications, payroll applications, software development applications, or any other suitable software application. After the account provisioning information has been set up, the rule based provisioning engine 62 may access the application connectors (e.g., app C connector 132, app D connector 134) to execute the provisioning (block 192). That is, the application connectors may be used to execute the provisioning to the target applications 16 (arrow 122) by delivering and setting up the provisioned applications 16 to the entity (such as applications on the employee's workstation). Further, in some embodiments, the application connectors may perform conversion/translations of the XML provisioning message 60 to a data-format understood by the particular applications 16 to be provisioned.

It should be noted that, in some embodiments, the account request 98 provisioning may also be accessed by looping back from the entity type provisioning 112, 114, and 116 performed for identity requests 96, as illustrated by dashed arrow 136. For example, a rule may indicate during a particular entity type provisioning 112, 114, and 116 that the entity should be provisioned an account for an application not included in a standard set of initial data and/or technology resources to provision. Thus, the rule based provisioning engine 62 may invoke the account request 98 provisioning to provision the additional account. To illustrate, a rule may indicate that an employee entity type should be provisioned app A (e.g., email), app B (e.g., VPN), and app C (e.g., word processing application software). As depicted, an employee being provisioned for the first time only has access to the app A (e.g., email) connector 118 and app B (e.g., VPN) connector 120. Therefore, the rule based processing engine 62 may invoke account request 98 provisioning (dashed arrow 136) to access the app C (e.g., word processing application software) provisioning 128 and the app C connector 128.

The rule based provisioning engine 62 may use a framework that includes components for email notification 138, auditing/logging 140, error handling 142, and message management 144. The email notification component 138 may send emails to the administrators of the provisioning system 14, developers of the provisioning system 14, or the like, if there are issues that arise during operation, such as errors. The auditing/logging component 140 may log the activity rule based provisioning engine 62. For example, the auditing/logging component 140 may log the flow of messages in and out of the rule based provisioning engine 62 including timestamps. The auditing/logging component 140 may also log any errors that occur with the rule based provisioning engine 62.

The error handling component 142 may catch any exceptions that are thrown while the rule based provisioning engine 62 is executing and perform remedial measures. The message management component 144 may manage the flow of messages in and out of the rule based provisioning engine 62. For example, if an unusually large number of messages are received by the rule based provisioning engine 62 at substantially the same time, the message management component 144 may use an algorithm to moderate the flow of messages so as not to greatly disturb the processing speed of the rule based provisioning engine 62. Moreover, the message management component 144 may resend messages if the messages stall or fail to send.

While only certain features of the present disclosure have been illustrated and described herein, many modifications and changes will occur to those skilled in the art. It is, therefore, to be understood that the appended claims are intended to cover all such modifications and changes as fall within the true spirit of the present disclosure.

1. A computer-implemented method, comprising:
creating one or more objects in response to a trigger event;
converting the one or more objects to a provisioning message;
determining whether the provisioning message includes a request for an identity or an account using one or more rule calls;
when the request is for the identity, determining a type of entity to provision and application accounts to provision for the entity using one or more rule calls;
when the request is for the account, determining which application accounts to provision for the entity using one or more rule calls; and
provisioning the application accounts for the entity as determined.

2. The computer-implemented method of claim 1, comprising: providing, via the one or more rule calls, provisioning rules based on the entity's identity and request type in the provisioning message.

3. The computer-implemented method of claim 2, comprising: indicating, in the one or more rule calls, that the request is for the identity when the entity's identity does not exist in an identity data store and the request type is to create a new identity.

4. The computer-implemented method of claim 2, comprising: indicating, in the one or more rule calls, that the request is for the account when the entity's identity exists in an identity data store and the request type is to provision a new application account, access rights, or both.

5. The computer-implemented method of claim 1, comprising: defining the one or more objects in a JavaScript object notation (JSON) data-format and defining the provisioning message in an extensible-markup language (XML) data-format.

6. The computer-implemented method of claim 1, comprising: populating the one or more objects with account and entity information using a web service prior to conversion to the provisioning message.

7. The computer-implemented method of claim 1, comprising: populating the provisioning message with requestor information when the request is for the identity and with identity information when the request is for the account.

8. The computer-implemented method of claim 1, comprising: indicating, via the one or more rule calls used when determining the type of entity to provision and application accounts to provision for the entity, which application accounts to provision based on the type of entity and request type.

9. The computer-implemented method of claim 1, comprising: looping back to the request for the account when the one or more rule calls indicates an additional account is to be provisioned to the type of entity being provisioned.

10. The computer-implemented method of claim 1, comprising: accessing one or more application connectors to deliver and set up the provisioned application accounts.

11. The computer-implemented method of claim 1, comprising: when the request is for the identity, determining a type of entity to de-provision and application accounts to de-provision for the entity using one or more rule calls;
when the request is for the account, determining which application accounts to de-provision for the entity using one or more rule calls; and
de-provisioning the application accounts for the entity as determined.

12. A system, comprising:
a processor-based workstation;
a processor-based provisioning system;
one or more data sources, technology resources, or both;
wherein the processor-based provisioning system is configured to:
create one or more objects in response to a trigger event activated by the processor-based workstation;
convert the one or more objects to a provisioning message;
determine whether the provisioning message includes a request for an identity or an account for the one or more data sources, technology resources, or both using one or more rule calls;
when the request is for the identity, determine a type of entity to provision and accounts, access rights, or both for the one or more data sources, technology resources, or both to provision for the entity using one or more rule calls;
when the request is for the account for the one or more data sources, technology resources, or both, determine which of the one or more data sources, technology resources, or both accounts, access rights, or both to provision for the entity using one or more rule calls; and
provision the one or more data sources, technology resources, or both accounts, access rights, or both for the entity as determined.

13. The system of claim 12, wherein provisioning accounts for the one or more data sources, technology resources, or both for the entity comprises accessing a respective connector for the data sources, technology resources, or both to setup the account for the data sources, technology resources, or both, and deliver the accounts, software, or both, for the data sources, technology resources, or both to a workstation of the entity.

14. The system of claim 12, wherein the provisioning message is populated with information related to a requestor of the provisioning, the identity of the entity to be provisioned, an operation to be performed during the provisioning, or some combination thereof, prior to being sent to connectors for the one or more data sources, technology resources, or both to be provisioned.

15. The system of claim 14, wherein the requestor information is obtained from an identity store when it is determined that the request is for the identity.

16. The system of claim 14, wherein the identity information of the entity is obtained from an identity store when it is determined that the request is for the account.

17. The system of claim 12, wherein the one or more objects are populated with account and entity information using a web service prior to conversion to the provisioning message.

18. A processor-based device, configured to:
create one or more objects in response to a trigger event;
convert the one or more objects to a provisioning message;
determine whether the provisioning message includes a request for an identity or an account using one or more rule calls;
when the request is for the identity, determine a type of entity to provision and accounts to provision for the entity using one or more rule calls;
when the request is for the account, determine which of the accounts to provision for the entity using one or more rule calls; and
provision the accounts for the entity as determined.

19. The processor-based device of claim 18, wherein the rule call used when determining whether the provisioning message includes the request for the identity or the account is based on an entity identification and a request type.

20. The processor-based device of claim 19, wherein the one or more objects comply with a standard for cross-domain identity management (SCIM) schema, wherein the schema is platform neutral and the objects represents the entity, a group of entities, or both in JavaScript objec notation (JSON) and extensible-markup language formats (XML).
